(19) United States
(12) Patent Application Publication
(10) Pub. No.: US 2020/0036749 A1
(43) Pub. Date: Jan. 30, 2020

(54) WEB BROWSER INCORPORATING SOCIAL AND COMMUNITY FEATURES

(71) Applicant: Microsoft Technology Licensing, LLC, Redmond, WA (US)

(72) Inventors: Juan Miguel Lavista Ferres, Kirkland, WA (US); John Bradley Kahan, Mercer Island, WA (US)

(21) Appl. No.: 16/043,836

(22) Filed: Jul. 24, 2018

(51) Int. Cl. H04L 29/06; G06F 17/30; H04L 12/58

(52) U.S. Cl. CPC H04L 63/1483; H04L 51/02; G06F 17/30899

(57) ABSTRACT

Systems, methods, and apparatuses are provided for enabling a web browser to incorporate social and community features. In one aspect, the web browser may provide and/or receive feedback from a feedback repository server corresponding to a website being accessed. The web browser may display the received feedback along with web page content received from a server hosting the website. In another aspect, the web browser may initiate a two-way communication channel with a communication server by transmitting and/or receiving one or more messages corresponding to a particular website that is being accessed in the browser. The communication channel may be initiated between other users visiting the same website, or between a visitor to a website and an endpoint associated with an owner of the website. The web browser may display website content received from a web hosting server, along with the messages sent or received from the communication server.

### BACKGROUND

Users visit websites for a variety of reasons, for instance, to access news, check account balances, research products or services, make purchases, etc. Some websites may appear harmless to an ordinary user, when in reality the websites are set up by malicious actors to mislead visitors. For example, a website may be designed to intentionally provide fake or inaccurate news content. In other examples, a website may mimic a popular website (e.g., a website of a banking institution) by presenting an identical or nearly identical layout as the original website in an attempt to trick visitors into providing personal information, such as login information, social security numbers, bank account information, or other sensitive information. In such examples, since the inaccurate or malicious websites appear to users as authentic, users may be easily deceived. With the increased reliance on using web browsers to visit websites to accomplish everyday tasks, the risk for deception across numerous contexts becomes greater.

Furthermore, when visitors access websites to research products or make purchases, it is burdensome for users to interact with other users to discuss such products or potential purchases. For instance, unlike patrons in a brick and mortar store, visitors of a website are not able to interact with other website visitors. As a result, a website visitor may need to post a message on a third-party website, such as a message board or social networking resource, with the hope of eliciting a response from other individuals. Not only is such a process a hinderance, it is also time consuming, requiring the visitor to wait hours or days (or even longer) to initiate an interaction with another user.

Additionally, while online retailers or other e-commerce entities providing items for sale online may enable a website visitor to chat with a customer service representative or a chat bot, such online interaction typically requires the website owner to hire a third-party designer to develop and implement chat features as part of the website itself. Such implementations are often proprietary, complex, and expensive, and must be integrated separately for each website.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and computer program products are provided for obtaining and displaying information corresponding to a website. A web browser may provide an access request to a server hosting the website to access the website. The web browser may also be configured to provide a feedback request including a website identifier to request information associated with the website to a feedback repository server. The web browser receives, from the server hosting the website, web page information corresponding to the website. The web browser also receives, from the feedback repository server, feedback associated with the website (e.g., user-generated feedback). The web page information and the feedback associated corresponding to the website may be displayed in the web browser.

In this manner, a web browser may present items of feedback corresponding to the website to a user when the website is accessed. For instance, the web browser may automatically request from the feedback repository server one or more items of feedback that other website visitors have generated identifying whether the website is fake, malicious, misleading, etc. Upon receiving the items of feedback from the repository, the web browser may display the feedback along with the website content, for example by displaying the feedback as an overlay or at a bottom portion of the browser, enabling the visitor to readily view the feedback on the same screen.

In other implementations, systems, methods, and computer program products are provided for establishing a communication channel in a web browser. A web browser may receive a request to access a website hosted by a website hosting server. The web browser may initiate a two-way communication channel with a communication server by transmitting a user-generated message to the communication server corresponding to the website and receiving a message from the communication server corresponding to the same website. The web browser may display the web page information, along with the user-generated message and the message received from the communication server.

Accordingly, the web browser may be configured to enable a website visitor to communicate, via one or more messages, with other remotely located visitors to the same website without requiring a user to perform additional navigation steps or launch additional software. In some other example embodiments, the web browser may also enable a visitor to easily transmit and receive messages with an endpoint corresponding to the website owner (e.g., a customer service representative).

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the embodiments and to enable a person skilled in the pertinent art to make and use the example embodiments.

FIG. 1 shows a block diagram of a system for displaying feedback information in a web browser, according to an example implementation.

FIG. 2 shows a flowchart of a method for displaying web page content and one or more items of feedback in a web browser, according to an example embodiment.

FIG. 3 shows a flowchart of a method for transmitting an item of feedback to a feedback repository server, according to an example embodiment.

FIG. 4 shows a block diagram of a system for establishing a two-way communication channel in a web browser, according to an example embodiment.

FIG. 5 shows a flowchart of a method for establishing a communication channel in a web browser, according to an example embodiment.

FIG. 6 shows a flowchart of a method for receiving an indication of a number of online users corresponding to a website identifier in a web browser, according to an example embodiment.

FIG. 7 shows a block diagram of a system for establishing a communication channel with an endpoint associated with an owner of a website, according to an example embodiment.

FIG. 8 shows a flowchart of a method for establishing a communication channel with an endpoint associated with an owner of a website, according to an example embodiment.

FIG. 9 is a block diagram of an example processor-based computer system that may be used to implement various example embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, are understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner

### II. Example Implementations.

As noted in the Background section above, users visit websites for a variety of reasons, for instance, to access news, check account balances, research products or services, make purchases, etc. Some websites may appear harmless to an ordinary user, when in reality the websites are set up by malicious actors to mislead visitors. For example, a website may be designed to intentionally provide fake or inaccurate news content. In other examples, a website may mimic a popular website (e.g., a website of a banking institution) by presenting an identical or nearly identical layout as the original website in an attempt to trick visitors into providing personal information, such as login information, social security numbers, bank account information, or other sensitive information. In such examples, since the inaccurate or malicious websites appear to users as authentic, users may be easily deceived. With the increased reliance on using web browsers to visit websites to accomplish everyday tasks, the risk for deception across numerous contexts becomes greater.

Furthermore, when visitors access websites to research products or make purchases, it is burdensome for users to interact with other users to discuss such products or potential purchases. For instance, unlike patrons in a brick and mortar store, visitors of a website are not able to interact with other website visitors. As a result, a website visitor may need to post a message on a third-party website, such as a message board or social networking resource, with the hope of eliciting a response from other individuals. Not only is such a process a hinderance, it is also time consuming, requiring the visitor to wait hours or days (or even longer) to initiate an interaction with another user.

Additionally, while online retailers or other e-commerce entities providing items for sale online may enable a website visitor to chat with a customer service representative or a chat bot, such online interaction typically requires the website owner to hire a third-party designer to develop and implement chat features as part of the website itself. Such implementations are often proprietary, complex, and expensive, and must be integrated separately for each website.

Implementations described herein address these and other issues through a web browser capable of providing a feedback request to a feedback repository server. The feedback request may include a website identifier for identifying the website for which feedback information is requested. The web browser may retrieve, from the feedback repository, one or more items of feedback associated with the website and display the feedback along with web page content received from a server hosting the website.

In this way, a web browser may display items of feedback comprising a message and/or a website rating indicating a level of trustworthiness of a particular website. For instance, upon loading a website, the web browser may concurrently display whether the website has been identified by other users as containing fake information (e.g., fake sellers, products, etc.), inaccurate information, malicious content, etc., avoiding the need for the visitor to separately research each website accessed. Accordingly, the graphical user interface of the computing device, including the web browser, may be enhanced by presenting such feedback to the visitor in this manner Furthermore, since the visitor need not separately initiate access requests to other resources (e.g., via one or more Internet searches, social media postings, etc.) to verify a website's trustworthiness, utilized network resources may be reduced through a centralized feedback repository that the web browser may access to obtain such information. Still further, by enabling a visitor to readily determine a website's trustworthiness concurrently with the accessing a website, the web browser may mitigate or prevent the unintentional transmission of the visitor's sensitive information (e.g., login information, social security information, bank account or credit card information, etc.), thereby reducing the risk of such information being used to by a malicious actor associated with a malicious website from accessing other computing resources (employer server devices, cloud-based servers associated with a personal account, bank account servers, etc.). As a result, both the network resources of such computing resources as well as the risk of an unintentional intrusion may be reduced. In some other implementations, identities of websites associated with numerous items of feedback corresponding to a lack of trustworthiness may be provided to an appropriate firewall service, or the like, to automatically block future access of the malicious website, further reducing network and computing resources.

Still further, example embodiments enabling trustworthiness information to be presented in conjunction with a website access enables the computing device accessing the website to reject or prevent (either automatically or through a user-initiated action) the installation of malicious software (e.g., malware) on the computing device upon accessing a malicious website. By receiving trustworthiness information in the manner described, the computing device may therefore be protected and secured from accidental or unintentional website accesses that seek to compromise visitors' computing devices.

Implementations described herein also address the above issues and other issues by enabling a communication channel to be established in a web browser. The web browser may be configured to initiate a two-way communication channel with a communication server by transmitting and/or receiving one or more messages corresponding to a particular website that a visitor is accessing. In some example implementations, the two-way communication channel may be initiated between a plurality of remotely located users visiting the same website. In other implementations, a two-way communication channel may be initiated between a visitor to a website and an endpoint associated with an owner of the website (e.g., a customer service representative). The web browser may display website content received from a web hosting server, along with the user-generated messages sent or received from the communication server.

This approach also has numerous advantages, including an enhancement to the graphical user interface of the computing device and the web browser, by presenting an interactive two-way communication stream to a user integrated within a window of the web browser concurrently displaying web page content, thereby avoiding the need for a user to open additional web browser windows or launch a separate application. Furthermore, because a visitor of a website may readily interact with other visitors to the same website without the need for additional navigation or applications, network and computing resources may be preserved for other uses, such as for obtaining and rendering content on the website being accessed (or any other content) or for other applications executing on the computing device. For instance, if a website visitor is seeking to discuss particular product (e.g., a car) presented on the website, the user need not generate unnecessary network traffic by navigating to other websites, such as a search engine or social media platform, to obtain interact with other users about the product. Rather, implementations described herein enables the web browser to initiate a two-way communication channel within the web browser, allowing the visitor to interact with other visitors or an endpoint associated with the website concurrently with accessing the website.

Still further, in the above examples, an owner or developer of a website need not redesign a website to implement features described herein. For instance, because such features may be integrated within a web browser, as opposed to redesigning each individual website for which the features are to be integrated, implementations enabling the receipt of feedback or the initiation of a two-way communication channel may be achieved independent of any particular website or platform.

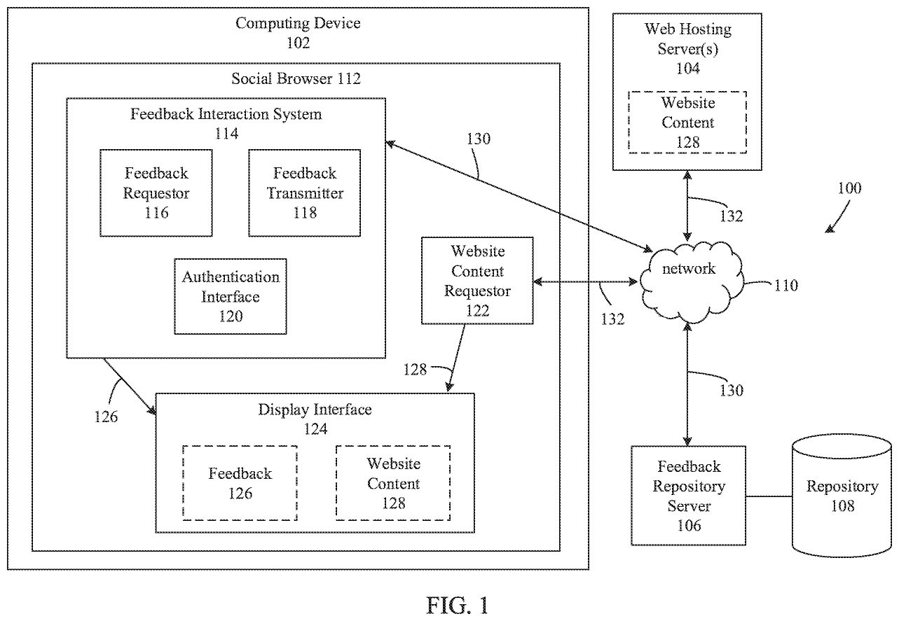

Example implementations will now be described that are directed to techniques for obtaining and displaying information corresponding to a website in a web browser. For instance, FIG. 1 shows a block diagram of an example system 100 for displaying feedback information in a web browser, according to an example implementation. As shown in FIG. 1, system 100 includes a computing device 102, web hosting server(s) 104, a feedback repository server 106, a repository 108, and a network 110. Network 110 may comprise one or more networks such as local area networks (LANs), wide area networks (WANs), enterprise networks, the Internet, etc., and may include wired and/or wireless portions. Computing device 102, web hosting server(s) 104, and feedback repository server 106 are communicatively connected via network 110. Though feedback repository server 106 and repository 108 are shown separate from web hosting server(s) 104, in an example, feedback repository server 106 and repository 108 may be implemented or included in web hosting servers(s) 104. In an implementation, computing device 102 and feedback repository server 106 may communicate via one or more application programming interfaces (API).

Web hosting server(s) 104 and feedback repository server 106 may form a network-accessible server infrastructure, such as a cloud computing server network. For example, web hosting server(s) 104 and feedback repository server 106 may comprise a group or collection of servers (e.g., computing devices) that are each accessible by a network such as the Internet (e.g., in a “cloud-based” implementation) to store, manage, and process data. Each of web hosting server(s) 104 and feedback repository server 106 may comprise any number of computing devices, and may include any type and number of other resources, including resources that facilitate communications with and between the servers, storage by the servers, etc. (e.g., network switches, storage devices, networks, etc.). Web hosting server(s) 104 and feedback repository server 106 may be organized in any manner, including being grouped in server racks, server clusters, or datacenters. In an implementation, web hosting server(s) 104 and feedback repository server 106 may be co-located (e.g., housed in one or more nearby buildings with associated components such as backup power supplies, redundant data communications, environmental controls, etc.) to form a datacenter, or may be arranged in other manners.

It is noted that in some example embodiments, web hosting server(s) 104 and feedback repository server 106 may be unaffiliated with each other. For instance, data on web hosting server(s) 104 may be configured and/or maintained by one or more website owners, while feedback repository server 106 is hosted by an unaffiliated or independent entity. In this manner, feedback associated with a particular website may be stored in repository 108 independent of any influence or control by website owners or web hosting servers.

In accordance with an implementation, web hosting server(s) 104 and feedback repository server 106 may be configured to service a particular geographical region. It is noted that the network-accessible server set may include any number of web servers and/or feedback repository servers, and each web server or feedback repository server may service any number of geographical regions worldwide.

Web hosting server(s) 104 may be configured to execute one or more services (including microservices), applications, and/or supporting services. A “supporting service” may include a cloud computing service/application configured to manage a set of web servers (e.g., a cluster of web servers in web hosting server(s) 104) to operate as network-accessible (e.g., cloud-based) computing resources for users. Examples of supporting services include Microsoft® Azure®, Amazon Web Services™, Google Cloud Platform™, IBM® Smart Cloud, etc. A supporting service may be configured to build, deploy, and manage applications and services on the corresponding set of servers. Each instance of the supporting service may implement and/or manage a set of focused and distinct features or functions on the corresponding server set, including virtual machines, operating systems, application services, storage services, database services, messaging services, etc. Supporting services may be written in any programming language. Each of web hosting server(s) 104 may be configured to execute any number of supporting services, including multiple instances of the same supporting service.

In accordance with example embodiments, web hosting server(s) 104 may comprise one or more web hosting platforms that provide, among other things, web and/or data hosting services for one or more websites. For example, web hosting server(s) 104 may be configured to receive an access request to access a website hosted by web hosting server(s) 104, and provide website content 128 in response to receiving the request. In implementations, an access request may identify a particular website by a uniform resource locator (URL), Internet Protocol (IP) address, or any other website identifier to obtain website content 128. Website content may include any type of information or data associated with a website, such as text, graphics, videos, etc. Web hosting server(s) 104 may comprise any number of client domains for hosting website content belonging to a plurality of clients or customers of a cloud services provider. In one example, client domains hosted by web hosting server(s) 104 may comprise website content for a plurality of unrelated or independent domains. In another example, web hosting server(s) 104 may provide hosting platforms corresponding to a cloud service subscription, and client domains may comprise a plurality of subscriber accounts corresponding to the cloud service subscription.

Computing device 102 comprises a social browser 112. Social browser 112 comprises a feedback interaction system 114, a website content requestor 122, and a display interface 124. Feedback interaction system 114 includes a feedback requestor 116, a feedback transmitter 118, and an authentication interface 120. Display interface 124 may be configured to display an item (or plurality of items) of feedback 126 and website content 128. Each of these components will be described in greater detail below.

Computing device 102 may comprise a computing device of a user (e.g., individual users, family users, enterprise users, governmental users, etc.) that is operable to access, via network 110, website content 128 hosted by web hosting server(s) 104. It is to be understood that system 100 may comprise any number of computing devices 102 and computing device may be located in any one or more locations. Computing devices 112 may include any number of computing devices, including tens, hundreds, thousands, millions, or even greater numbers of computing devices. Computing device 102 may comprise a mobile device, including but not limited to a mobile computing device (e.g., a Microsoft® Surface® device, a personal digital assistant (PDA), a laptop computer, a notebook computer, a tablet computer such as an Apple iPad™, a netbook, etc.), a mobile phone, a handheld device, a wearable computing device, or a head mounted device. Computing device 102 may also comprise a stationary device such as but not limited to a desktop computer or PC (personal computer), a video game console, a set-top box, or a television capable of accessing website content 128 over network 110.

Computing device 102 may include an input interface for interacting with one or more components included therein, including but not limited to social browser 112. The input interface may enable a user to cause social browser 112 to request website content 128 via network 110. In implementations, the input interface may also enable a user to cause social browser to receive and/or transmit an item of feedback via network 110 corresponding to a particular website that is being accessed by social browser 112. The input interface may comprise a keyboard input, a microphone, a camera, a touchscreen, a touch pad, or any other type of device for capturing a user input. Accordingly, a user input may be captured in any form, including audio, video, text, touchscreen, touchpad, stylus or pen-based inputs (e.g., Microsoft Windows® Ink), gesture-based inputs, etc.

In example implementations, social browser 112 comprises a web browser that is operable to access, among other things, website content 128 from web hosting server(s) 104 via network 110. For example, the web browser may comprise an augmented or modified version of an existing web browser such as a modified version of a Microsoft® Internet Explorer web browser, a Google® Chrome web browser, an Apple® Safari web browser, etc. In some implementations, one or more components of social browser 112, including but not limited to feedback interaction system 114, may be implemented via one or more plugins. For instance, one or more plugins may enable feedback interaction system 114 to initiate a communication channel with one or more servers, such as feedback repository server 106, to retrieve and/or transmit items of feedback as described herein.

As will be described in greater detail below, feedback interaction system 114 may be configured to request one or more items of feedback 126 from feedback repository server when accessing a website. In other implementations, feedback interaction system 114 may enable a user to transmit an item of feedback corresponding to an accessed website to feedback repository server 106. In this manner, social browser 112 may cause one or more items of feedback 126 corresponding to a website to be displayed, along with website content 128 corresponding to the same website. Feedback interaction system 114 may interact with feedback repository server 106 over network 110 in any suitable manner (e.g., HTTP requests and responses, etc.), and may include encrypted and/or unencrypted transmissions.

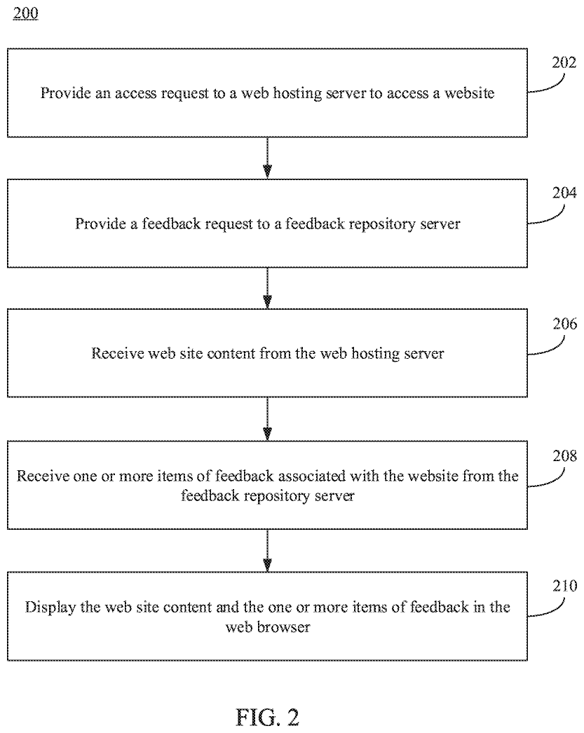

Accordingly, in implementations, presenting one or more items of feedback in a web browser along with website content may be achieved. Feedback interaction system 114 may obtain one or more items of feedback associated with a website in various ways. For example, FIG. 2 shows a flowchart 200 of a method for displaying web page content and one or more items of feedback in a web browser, according to an example embodiment. FIG. 2 is described with continued reference to FIG. 1. Other structural and operational implementations will be apparent to persons skilled in the relevant art(s) based on the following discussion regarding flowchart 200 and system 100 of FIG. 1.

Flowchart 200 begins with step 202. In step 202, an access request is provided to a web hosting server. For instance, with reference to FIG. 1, website content requestor 122 provides 132 an access request to web hosting server(s) 104 to obtain website content 128. The access request may comprise a website identifier associated with the requested web content 128. For example, the website identifier may comprise a URL, an IP address, or any other identifying information suitable for web hosting server(s) 104 to identify the requested content. Website content requestor 122 may provide the access request to web hosting server(s) 104 in any manner known and appreciated by those skilled in the art, including but not limited to a Hypertext Transfer Protocol (HTTP) request or the like.

In implementations, website content requestor 122 may provide the access request to web hosting server(s) 104 in response to a user interaction with social browser 112. For example, a user may interact with one or more user interface controls (e.g., by typing in a website identifier, clicking on an interactive link, scrolling through a webpage, etc.) in social browser 112 to cause website content requestor 122 to request the desired content.

In step 204, a feedback request is provided to a feedback repository server. For instance, with continued reference to FIG. 1, feedback requestor 116 provides 130 a feedback request to feedback repository server 106. Feedback request may include a request for information associated with the website, such as one or more message, ratings, alerts, etc. In some implementations, the information associated with a website may be user-generated. For example, a user visiting a particular website may interact with a user interface of social browser 112 to input a message, rating, alert, etc. for the website. Upon receiving the user input, feedback transmitter 118 may transmit the received information to feedback repository server 106 for storage in repository 108.

In other implementations, information associated with a website may be automatically generated. For example, feedback repository server 106 may automatically determine, based on one or more user-generated items of feedback, that a particular website is untrustworthy, malicious, fake, etc. Accordingly, feedback repository server 106 may store, in repository 108, information indicating that the website has been identified or flagged as potentially untrustworthy, malicious, fake, etc. By analyzing user-generated items of feedback, feedback repository server 106 may further provide the website identifier (e.g., URL) to a firewall or a blacklist service where such items of feedback for a particular website indicates that the website is likely untrustworthy. In this manner, the website may be automatically blocked from accessing, thereby reducing the likelihood that users of social browser 112 may be deceived by the malicious site.

In example embodiments, the feedback request provided to feedback repository server 106 may include a website identifier. The website identifier may identify the website that a user of social browser 112 is attempting to access, as described above with respect to step 202. For instance, when a user interacts with social browser 112 to visit a particular website, feedback requestor 116 may transmit a request for feedback to feedback repository server 106 in addition to transmitting an access request to web hosting server(s) 104 to retrieve website content 128 associated with the same website identifier. It is noted that website content requestor 122 may provide an access request to web hosting server(s) 104 before, after, or concurrently with feedback requestor 116 transmitting a feedback request to feedback repository server 106.

In step 206, website content is received from the web hosting server. For instance, with reference to FIG. 1, website content requestor 122 receives 132 website content 128 from web hosting server(s) 104. For instance, in response to a user interaction with social browser 112 to access a website, web hosting server(s) 104 may provide website content 128 corresponding to the website to website content requestor 122 via network 110. Web hosting server(s) may determine which content to provide based, for instance, on a website identifier (e.g., a URL) included within the access request. Web hosting server(s) 104 may obtain website content 128 from one or more storage devices co-located with web hosting server(s) 104, located remotely to web hosting server(s) 104, or may direct a cloud-based repository to provide website content 128 corresponding to the website identifier to website content requestor 122.

In step 208, one or more items of feedback associated with the website are received from the feedback repository server. For instance, with continued reference to FIG. 1, feedback requestor 116 may receive one or more items of feedback 126 from feedback repository server 106. In implementations, feedback repository server 106 may provide one or more items of feedback 126 to feedback requestor 116 in any suitable format, including but not limited to Extensible Markup Language (XML), Hyper Text Markup Language (HTML), or any other format suitable for rendering by social browser 112. As used herein, feedback 126 may include, but is not limited to, one or more of a message, a rating, an alert, and/or a user identifier.

Feedback repository server 106 may identify feedback 126 to provide to feedback requestor 116 from repository 108 based on a website identifier included in the feedback request. For example, repository 108 may store information for a plurality (e.g., thousands or millions) of websites based on an associated website identifier. In implementations, repository 108 may store information for each of a plurality of websites corresponding to an associated website identifier in any suitable format or data structure, including but not limited to, one or more text files, database files, spreadsheets, documents, etc. Though feedback repository server 106 and repository 108 are shown separate from each other in FIG. 1, in an example, feedback repository server 106 may be implemented on the machine or set of machines, or otherwise be co-located with each other.

As discussed above, repository 108 may store information that is user-generated (e.g., user generated messages, ratings, alerts), and/or automatically generated (e.g., automatic determinations of a particular website's trustworthiness based on one or more items of user-generated information corresponding to the website). For instance, if repository 108 contains a threshold number of items of feedback identifying a particular website as malicious, repository 108 may store, in addition to the user-generated items of feedback, an alert, flag, warning, etc. indicating that the website has been identified as potentially malicious.

In some implementations, an item of feedback in repository 108 may be associated with an identifier that identifies the user that generated the item of feedback. For instance, the user identifier may comprise a name, an alias, a username (e.g., corresponding to a cloud subscription or other account), an email address, or the like. In other implementations, the user identifier may be omitted or indicate that a user anonymously provided the item of feedback. Accordingly, in implementations, when a user provided feedback for storage in repository 108, a new row, entry or other data structure may be created that includes a user identifier (or anonymous indication), a message corresponding to the user-generated feedback, a rating provided by the user, and a website identifier associated with the feedback.

Feedback repository server 106 may provide items of feedback to feedback requestor 116 based on a number of factors. For instance, feedback repository server 106 may provide items of feedback to feedback requestor 116 based on the number of items of feedback in repository 108 corresponding to the website identifier. In an illustrative example, where repository 108 does not contain any items of feedback corresponding to the website identifier, feedback repository server 106 may transmit an indication that feedback does not exist for the website identifier. In other examples, where repository 108 contains an excessive number of items of feedback corresponding to the website identifier (e.g., greater than an amount that may be displayed on a single screen of computing device 102), feedback repository server 106 may transmit a subset of the items of feedback (e.g., a number of most recent items of feedback, the most popular items of feedback, etc.). In other example embodiments, feedback repository server 106 may transmit a number of items of feedback greater than the amount that may be suitably displayed on a single screen of computing device 102. Feedback requestor 116 may display certain items of the received feedback, while storing the remaining items in a local cache of social browser 112 for a subsequent display. In such a manner, delays associated with retrieving additional items of feedback may be reduced.

In yet other implementations, feedback requestor 116 may request additional items of feedback from feedback repository server 106, either automatically or in response to a user interaction with an interface control (e.g., by clicking on a link to display a next page of feedback or to retrieve additional feedback). In such an example, feedback repository server 106 may provide additional items of feedback in responses to the additional feedback requests.

In step 210, the web site content and the one or more items of feedback are displayed in the web browser. For instance, with continued reference to FIG. 1, display interface 124 obtains website content 128 and feedback 126 comprising one or more items of feedback for display in social browser 112. Feedback 126 displayed via display interface 124 may include one or more items of feedback received from feedback repository server 106. For each item of feedback displayed, display interface 124 may display one or more of a message, a rating (e.g., as stars, thumbs up or thumbs down, etc.), an alert or warning, a user identifier or an anonymous indication associated with the item of feedback, or a location associated with the user identifier. Display interface 124 may also be configured to display an average or an aggregation of one or more items of feedback (e.g., an average user rating or the like). In yet other example embodiments, display interface 124 may be configured to also display one or more additional items of information associated with the website along with feedback 126, such as a visit count associated with the website identifier, a publication or revision date of the website, an identifier of the registered owner of the website, etc. Such additional information may be retrieved from feedback repository server 106 and/or from other servers, such as web hosting server(s) 104.

In some implementations, display interface 124 may be configured via one or more user interactive controls (e.g., options or toggles). For instance, a user interface of social browser 112 may provide an interactive control that disables or otherwise hides feedback 126 from being displayed in social browser 112. In other implementations, an interactive control may be provided that disables social browser 112 from retrieving or transmitting feedback entirely for a particular website or for all websites accessed in social browser 112. In other implementations, display interface 124 may be configured to display feedback 126 in response to a user interaction with a function to display such feedback (e.g., displaying feedback for a website on demand by clicking or selecting an a feedback icon, toggle, etc.).

As described earlier, repository 108 may comprise many items of feedback (e.g., hundreds or even thousands of items of feedback) associated with a particular website identifier. In such an example, display interface 124 may perform one or more pagination functions to display an appropriate number of items of feedback at a given time in social browser 112. For instance, display interface 124 may display a suitable number of items of feedback on a first page and provide an interactive control enabling a user to retrieve and/or display additional feedback. Display interface 124 may retrieve such additional feedback from a local cache of social browser 112 and/or cause feedback requestor 116 to obtain additional items of feedback from feedback repository server 106.

In yet another implementation, display interface 124 may be configured to display feedback 126 based on items of feedback associated with an entire domain or a particular web page. For instance, display interface 124 may display feedback 126 corresponding to a domain (e.g., http://www.microsoft.com) associated with the website identifier, or may display feedback associated with the particular web page (e.g., http://www.microsoft.com/en-us/windows) currently being displayed in social browser 112. In some other instances, display interface 124 may enable a user to toggle between displaying feedback 126 corresponding to a domain and/or individual web pages.

In other examples where repository 108 does not contain any items of feedback corresponding to a particular website identifier, display interface 124 may display an indication or notification that no such feedback exists. Such an absence of feedback may indicate to a user that the user has accessed the wrong website (e.g., due to a typographical error in the URL input into social browser 112). In other examples, if the user is directed to a website (e.g., via a phishing email) appearing to be part of a well-known banking institution, an absence of feedback (or a lower number of items of feedback than expected) may indicate that the website is fake and intended to deceive the user into providing sensitive information.

In yet other implementations, display interface 124 may provide one or more interactive controls enabling a user to submit feedback. For instance, display interface 124 may comprise an interface to select a number of stars or a thumbs up/down rating, input a message, select an option from a plurality of options to identify a website categorization (e.g., identifying the website as containing false news, phishing for information, selling non-existent products, etc.), or any other interactive control for inputting information regarding a trustworthiness level associated with the website.

Display interface 124 may display feedback 126 in any manner For instance, feedback 126 may be presented in a superimposed manner (e.g., semi-transparent) on top of website content 128 or may be presented on top of website content 128 in an opaque manner In examples, feedback 126 and website content 128 may be displayed concurrently such that feedback 126 and website content 128 are presented in separate but concurrently-displayed sections of social browser 112. For example, feedback 126 may be presented at a particular side of social browser 112 (e.g., a top, bottom, right, or left side) with website content 128 concurrently displayed at another side of social browser 112, may be presented in a fixed area within social browser 112, may be moved within social browser 112 to another location within social browser 112, may be adjusted in size, etc. based on a user input. In other examples, feedback 126 need not be concurrently displayed with website content 128. For instance, feedback 126 may be displayed in social browser 112 in a manner to partially or completely obscure website content 128.

Display interface 124 may further comprise one or more interactive controls to enable feedback 126 to be displayed or sorted based on a user's preferences (e.g., displaying feedback from authenticated and/or unauthenticated users, sorting items of feedback based on a date received, a rating level, etc.).

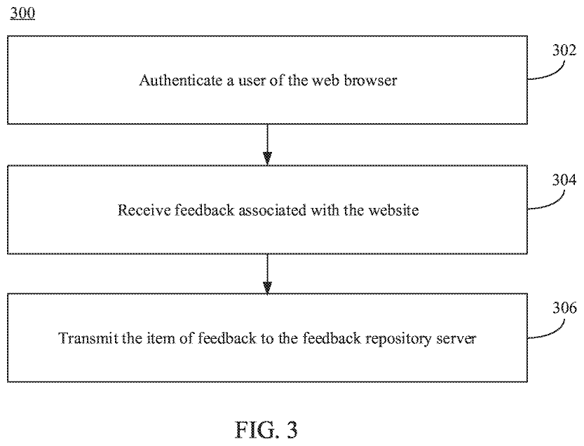

As described above, in examples, feedback interaction system 114 may enable a user to transmit feedback corresponding to a website being accessed in social browser 112 in various ways. For instance, FIG. 3 shows a flowchart 300 of a method for transmitting an item of feedback to a repository server, according to an example embodiment. In an example, the method of flowchart 300 may be implemented by system 100, as shown in FIG. 1. Other structural and operational implementations will be apparent to persons skilled in the relevant art(s) based on the following discussion regarding flowchart 300.

Flowchart 300 begins with step 302. In step 302, a user of the web browser is authenticated. For instance, with reference to FIG. 1, authentication interface 120 may be configured to authenticate a user of social browser 112. Authentication interface 120 may authenticate a user in various ways. For example, a user may be input login credentials (e.g., a username, email address, password, etc.) into social browser 112. Authentication interface 120 may determine whether the user has successfully logged into social browser 112 based on the credentials. The user login information need not be associated with social browser 112 in embodiments. For instance, in another implementation, the user login information may correspond to a cloud-based subscription or account providing one or more online services to the user (e.g., a Microsoft® account, a Google® account, etc.). In implementations, login credentials associated with a user may be inputted via any suitable interface, including but not limited to a keyboard input (e.g., a username/password), a touch screen input (e.g., a fingerprint scanner), a camera (e.g., for use in facial and/or retinal recognition), or other input device for receiving a user input. The authentication methods utilized may include biometric authentication methods, multi-factor authentication methods, or the like.

In implementations, authentication interface 120 may authenticate a user each time a feedback request is provided to and/or received from feedback repository server 106, at predetermined intervals or scheduled (e.g., once per day, week, etc.), or may authenticate a user based on previously inputted credentials. For instance, once a user inputs login credentials into social browser 112, authentication interface 120 may automatically keep the user logged in until the user logs out.

In some other implementations, authentication interface 120 may authenticate a user based on a device identifier. For example, each computing device requesting and/or transmitting feedback to feedback repository server 106 may comprise one or more unique identifiers, such as an Internet Protocol (IP) address, a Media Access Control (MAC) address, or other unique identifier. When a feedback request is to be received or transmitted, authentication interface 120 may communicate with feedback repository server 106 to authenticate the computing device.

By authenticating a user, based on login information or an identifier associated with the computing device, or in any other manner, feedback repository server 106 may be configured to provide and/or receive feedback only from authenticated users. In this manner, feedback repository server 106 may avoid the likelihood of transmitting or receiving feedback from malicious actors, such as web robots. In some other implementations, authentication interface 120 may be configured to authenticate a user when such a user seeks to transmit feedback to feedback repository server 106, but not when the user seeks to obtain previously stored feedback from feedback repository server 106. As a result, feedback repository server 106 may transmit feedback to authenticated and/or authenticated users, but may store feedback only for those users that are authenticated. In this way, feedback repository server 106 may prevent malicious actors or duplicative posters from storing feedback that is likely to be legitimate.

It is noted that example embodiments are not limited to only storing authenticated feedback. In some implementations, feedback repository server 106 may enable the storage of both authenticated and authenticated feedback. For instance, unauthenticated feedback may include feedback that was anonymously transmitted to feedback repository server 106. Based on a request for feedback received by feedback requestor 116, feedback repository server 106 may transmit only authenticated items of feedback, only unauthenticated items of feedback, or both authenticated and unauthenticated items of feedback.

In step 304, an item of feedback associated with the website is received. For instance, with reference to FIG. 1, a user may generate one or more items of feedback for a website currently being accessed for transmission to feedback repository server 106. Feedback transmitter 118 may receive an item of feedback in any number of ways, including via one or more user interface controls of social browser 112.

For example, a user visiting a website may input a message, a rating (e.g., as stars, thumbs up or thumbs down, etc.), an alert or warning, a user identifier (name, alias, etc. or an anonymous indication), or a location, a website categorization (e.g., identifying the website as containing false news, phishing for information, selling non-existent products, etc.), or any other input regarding a trustworthiness level associated with the website. The item of feedback may indicate, for instance, whether the user believes the website to be legitimate, fake, containing inaccurate information, deceptive, malicious, or otherwise trustworthy or untrustworthy as described herein.

In some implementations, social browser 112 may comprise one or more interactive controls that a user may select to launch or open a dialogue box to provide an item of feedback associated with the currently accessed website. For example, display interface 124 may be configured to display previously stored feedback obtained from feedback repository 106 in a manner as described above. If a user desires to provide feedback upon accessing a website, the user may select one or more options to cause display interface 124 to display one or more fields (e.g., text entry fields, check boxes, star ratings or the like, etc.) in which feedback information may be inputted.

In step 306, the item of feedback is transmitted to the feedback repository server. For instance, with respect to FIG. 1, feedback transmitter 118 may transmit 130 the user-generated item of feedback to feedback repository server 106 via network 110. In implementations, feedback transmitter 118 may transmit a website identifier associated with the item of feedback to feedback repository 106. Where a user of social browser 112 has been authenticated as described above, feedback transmitter 118 may be configured to transmit the item of feedback and the website identifier based on such authentication (e.g., by signing the package for transmission with user authentication information). In implementations, feedback transmitter 118 may transmit the user-generated item of feedback and the website identifier in an encrypted or unencrypted format.

Feedback repository server 106 may store the user-generated item of feedback in a variety of ways as described above. For instance, feedback repository server 106 may store, in repository 108, a user identifier or anonymous indicator, a location, a rating, a message, etc. corresponding to the website being accessed in social browser 112.

The website identifier may include a URL or the like identifying the website for which the item of feedback relates. Repository 108 may store the user-generated item of feedback based on a domain associated with the website (e.g., at the domain-level), and/or may store the item of feedback based on the individual webpage being accessed (e.g., at a URL level). In some implementations, the determination regarding whether to store an item of feedback at the domain level or at the URL may be made automatically (e.g., based on a level of web traffic associated with a particular domain or URL). For example, feedback repository server 106 may determine, based in a heuristic or other statistical analysis, that an item of feedback corresponding to a particular website identifier should be stored at the domain level, while an item of feedback for corresponding to another website identifier should be stored at the URL level.

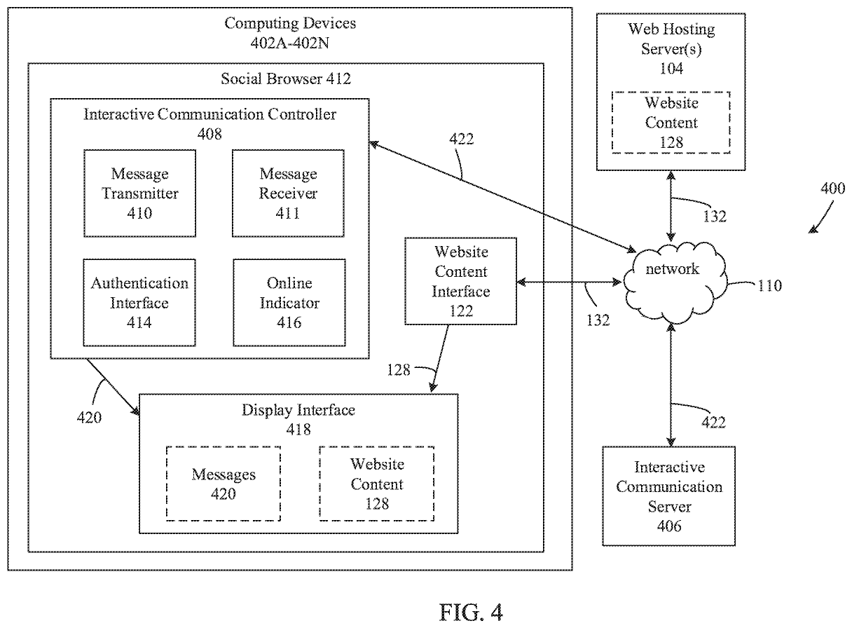

In example embodiments, a social browser may enable a user to communicate with another entity through one or more sent or received messages. For instance, FIG. 4 shows a block diagram of an example system 400 for establishing a two-way communication channel in a web browser, according to an example implementation. As shown FIG. 4, system 400 includes one or more computing devices 402A-402N, web hosting server(s) 104, network 110, and an interactive communication server 406.

Computing devices 402A-402N are examples of computing device 102 described above with reference to FIG. 1. As shown in FIG. 4, computing device(s) 402A-402N comprise a social browser 412. Social browser 412 includes an interactive communication controller 408, website content interface 122, and a display interface 418. Social browser 412 and display interface 418 are examples of social browser 112 and display interface 124, respectively, described above with respect to FIG. 1.

Interactive communication controller 408 includes a message transmitter 410, a message receiver 411, an authentication interface 414, and an online indicator 416. Interactive communication server 406 is configured to enable computing devices 402A-402N to communicate with each other via interactive communication controller 408. In implementations, interactive communication server 406 may be implemented as part of or separate from feedback repository server 106 described with reference to FIG. 1. Each of these components will be described in greater detail below.

Note that the variable “N” is appended to various reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

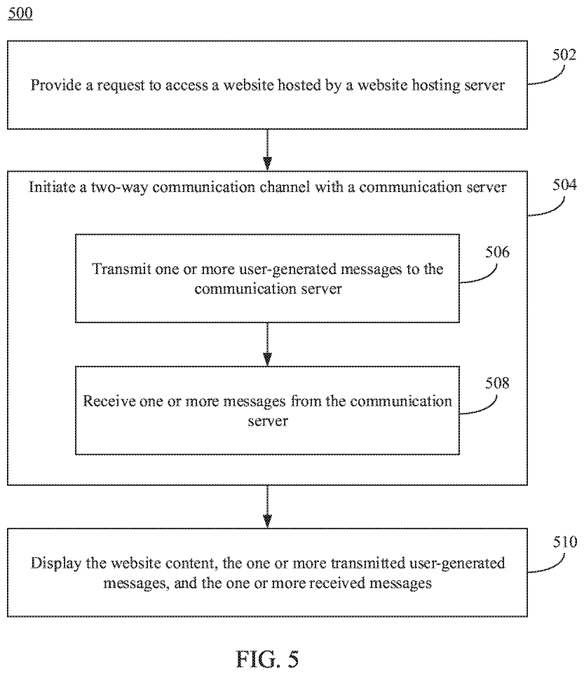

In examples, interactive communication controller 408 may enable computing devices 402A-402N to communicate with each other in a variety of ways. For instance, FIG. 5 shows a flowchart 500 of a method for establishing a communication channel in a web browser, according to an example embodiment. In an example, the method of flowchart 500 may be implemented by system 400, as shown in FIG. 4. Other structural and operational implementations will be apparent to persons skilled in the relevant art(s) based on the following discussion regarding flowchart 500.

Flowchart 500 begins with step 502. In step 502, a request to access a website hosted by a website hosting server is provided. For instance, with reference to FIG. 4, website content interface 122 may provide an access request 132 to web hosting server(s) 104 via network 110 to access certain website content. Step 502 may be carried out in a similar manner as described above with respect to step 202 of FIG. 2.

In step 504, a two-way communication channel with a communication server is initiated. For instance, with continued reference to FIG. 4, interactive communication controller 408 is configured to initiate 422 a two-way communication channel with interactive communication server 406 via network 110. In example implementations, the two-way communication channel may enable users of communicating devices 402A-402N to communicate with each other through social browser 412 executed on each user's respective computing device. The two-way communication channel may be initiated in various ways. For instance, a user of social browser 412 may interact with an interactive user control to initiate the way-way communication channel with interactive communication server 406. In some examples, the interactive user control may include a toggle, an option, a hyperlink, or other selectable element in display interface 418 that a user may select. Upon selection or activation of the interactive user control, the two-way communication channel may be initiated with interactive communication server 406 via network 110, thereby enabling interactive communication controller 408 to send and/or receive messages to interactive communication server 406.

In step 506, one or more user-generated messages are transmitted to the communication server. For instance, with reference to FIG. 4, message transmitter 410 may transmit one or more user-generated messages via network 110 to interactive communication server 406. Messages may be transmitted to interactive communication server 406 before, after, or in parallel with website content interface 122 transmitting an access request to web hosting server(s) 104 to access a website. Message transmitter 410 may obtain the one or more user-generated messages in various ways. For instance, a user of social browser 412 may interact with one or more user interface elements to input a message for transmission. The message may comprise a text string, a picture, etc. or any other message or content that the user intends on transmitting to interactive communication server 406.

In implementations, message transmitter 410 is configured to transmit the one or more user generated messages to interactive communication server 406 along with a website identifier (e.g., a URL) corresponding to the website being accessed in social browser 412. In this manner, interactive communication server 406 may determine, based on the received website identifier, which website the received message relates. As a result, interactive communication server 406 can enable the communication of such messages to other visitors of the same website using the received website identifier.

In step 508, one or more messages are received from the communication server. For example, with reference to FIG. 4, message receiver 411 may be configured to receive 422 one or more messages from interactive communication server 406 via network 110. Messages received from communication server 406 may comprise user-generated messages (e.g., messages originating from any one of computing devices 402A-402N). In other implementations, messages received from communication server 406 may comprise one or more automatically generated messages or messages received from another computing device, as will be described below.

Message receiver 411 may receive from interactive communication server 406 one or more messages corresponding to the website currently being accessed in social browser 412. For instance, message receiver 411 may receive each message from interactive communication server 406 corresponding to the website identifier associated with the accessed website. As a result, interactive communication controller 408 may enable a user to transmit and receive of messages in social browser 412 corresponding to a particular website being accessed with other users of social browser 412 accessing the same website.

In implementations, interactive communication controller 408 and interactive communication server 406 may transmit messages with a push method, a pull method, or a combination of both. For instance, message receiver 411 may transmit a request via network 110 to interactive communication server 406 for messages corresponding to the website identifier. Message receiver 411 may transmit such a request at predetermined intervals (e.g., every second, ten seconds, etc.). In other implementations, interactive communication server 406 may push messages received from one or more computing devices 402A-402N corresponding to the website identifier to all other computing devices 402-402N that are also accessing the same website corresponding to the website identifier (e.g., at predetermined intervals, or each time a new message is received). In this manner, interactive communication server 406 may be configured to transmit or broadcast all received messages to each of computing devices 402A-402N that are accessing the same website, thus enabling a two-way communication channel within social browser 412 between a plurality of computing devices 402A-402N.

In implementations, the one or more messages received by message receiver 411 may include messages generated at a point in time after a user of social browser 412 accessed the website corresponding to the website identifier. For instance, a user of social browser 412 engaging in a two-way communication with interactive communication server 408 may be able to view one or more messages since the user initiated the two-way communication session. In other instances, a history of prior messages corresponding to the website identifier may be received by message receiver 411. In such an example, interactive communication server 406 may be configured to store a history of messages corresponding to one or more website identifiers in a suitable storage or repository. In yet another implementation, a user of social browser 412 may interact with a user control to manually receive and/or search one or more prior messages corresponding to the website identifier.

In some example embodiments, interactive communication controller 408 may include authentication interface 414. Authentication interface 414 of FIG. 4 may be similar to authentication interface 120 described with reference to FIG. 1. Accordingly, in examples, interactive communication controller 408 may authenticate a user of social browser 412 prior to transmitting and/or receiving messages to interactive communication server 406. In such an example, each communicated message may include a website identifier, as discussed above, as well as user identifying information (e.g., a name, email address, alias, location, etc.). In other examples, transmission and receipt of messages between interactive communication controller 408 and interactive communication server 406 may be conducted in an anonymous manner

In step 510, the website content, the one or more transmitted user-generated messages, and the one or more received messages are displayed. For instance, with reference to FIG. 4, display interface 418 may be configured to display messages 420, comprising one or more messages transmitted by message transmitter 410 and one or more messages received by message receiver 411, along with website content 128. Display interface 418 may be further configured to display one or more additional items of information associated with each sent or received message, such as a user identifier, a location of the user, a timestamp, etc. associated with each message. In some example embodiments, display interface 418 may also display a notification or a message indicating whether another user is currently typing a message. In implementations, display interface 418 may comprise one or more interactive user controls that, when selected, enable a user of social browser 412 to configure and/or customize the manner in which messages 420 and website content 128 are displayed in social browser 412.

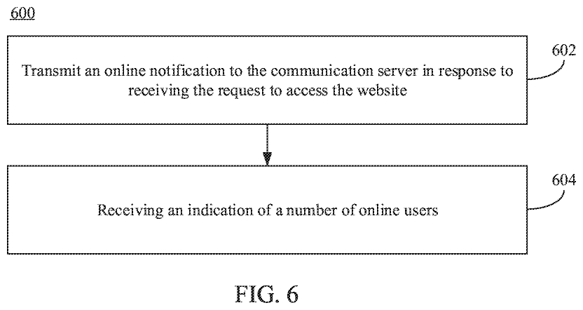

In examples, interactive communication controller 408 may be configured to display a status regarding other online users corresponding to the website identifier. For instance, FIG. 6 shows a flowchart 600 of a method for receiving an indication of a number of online users corresponding to a website identifier in a web browser, according to an example embodiment. In an example, the method of flowchart 600 may be implemented by system 400, as shown in FIG. 4. Other structural and operational implementations will be apparent to persons skilled in the relevant art(s) based on the following discussion regarding flowchart 600.

Flowchart 600 begins with step 602. In step 602, an online notification is transmitted to a communication server in response to receiving a request to access a website. For instance, with reference to FIG. 4, online indicator 416 may be configured to transmit an indication to interactive communication server 406 indicating that a user of social browser 412 has accessed a website corresponding to a website identifier. In some implementations, the indication may be transmitted in response to website content interface 122 receiving an access request to access a website. As a result, when a user accesses a website, online indicator 416 may be configured to automatically indicate to interactive communication server 406 that the user has accessed the website corresponding to the website identifier and therefore may be available for communication with other users.

In this manner, interactive communication server 406 may be configured to identify each user currently accessing a particular website. Based on an online indication received from online indicator 416 of one or more computing devices 402A-402N, Interactive communication server 406 may thereby determine the number of users online corresponding to a particular website identifier available for communication with each other.

In some other implementations, online indicator 416 may transmit an online indicator in response to some other action, such as a user-initiated action. For example, online indicator 416 may be configured to transmit such an indication in response to an express user selection indicating that the user is available to chat. In other examples, online indicator 416 may transmit such an indication in response to a user interface action of opening a chat window, or otherwise initiating a two-way communication channel as described herein.

It is also noted and understood that features described herein, including but not limited to message transmissions and/or transmissions of online indications, may be automatically disabled in some implementations. For example, where a user has enabled an incognito or private mode of social browser 412, message transmissions and/or online indication transmissions may be automatically disabled. In some other examples, a user may enable such features based on a user interaction with social browser (e.g., by interacting with an appropriate interface element, logging in, etc.). In yet another example, features described herein may be disabled based on other publicly accessible information generated by a website owner or administrator, such as information contained within a root directory of a website (e.g., a “robots.txt” file or the like).

In step 604, an indication of a number of online users is received. For instance, with reference to FIG. 4, online indicator 416 may receive, from interactive communication server 406, an indication of a number of users currently online corresponding to the website identifier. In response to receiving the indication, online indicator 416 may cause display interface 418 to display information corresponding to the number of users currently online that are also accessing the same website. In some examples, display interface 418 may display such an indication automatically (e.g., without an express user action to indicate the number of online users), or may display such an indication in response to a user interaction with an appropriate interface element (such as selection of an interface element to display a number of online users or to initiate a two-way communication session with other online users).

In some example embodiments, a social browser may enable a user to communicate with an endpoint associated with an owner of a website, such as a customer service representative or the like. For instance, FIG. 7 shows a block diagram of an example system 700 for establishing a communication channel with an endpoint associated with an owner of a website, according to an example implementation. As shown FIG. 7, system 700 includes computing devices 402A-402N, web hosting server(s) 104, network 110, and interactive communication server 406, an owner computing device 708, and a chatbot 710.

In implementations, owner computing device 708 and chatbot 710 are endpoints associated with an owner of a website. For example, owner computing device 708 may comprise a desktop computer, a notebook, a tablet, a smartphone, etc. of one or more users associated with an owner of the website. In some examples, the users may include customer service representatives, or other individuals designated by the owner to respond to questions transmitted to interactive communication server 406 by users of computing devices 402A-402N.

Chatbot 710 may comprise one or more computing devices or cloud-based services implemented on one more server capable of automatically responding to questions transmitted to interactive communication server 406 by users of computing devices 402A-402N. For example, chatbot 710 may comprise a plurality of automated responses based on commonly asked questions by users of computing devices 402A-402N. In other examples, chatbot 710 may be configured to intelligently interact with users of computing devices 402A-402N using a machine learning model or the like. In some implementations, interactions with chatbot 710 may be automatically forwarded, transmitted, or escalated to a user of owner computing device 708 in the event chatbot 710 is unable to answer a question. In this manner, users of computing devices 402A-402N interacting with an endpoint associated with a website owner may be unable to discern the difference between an interaction with a live representative (e.g., a user of owner computing device 708) or an automated response system (e.g., chatbot 710).

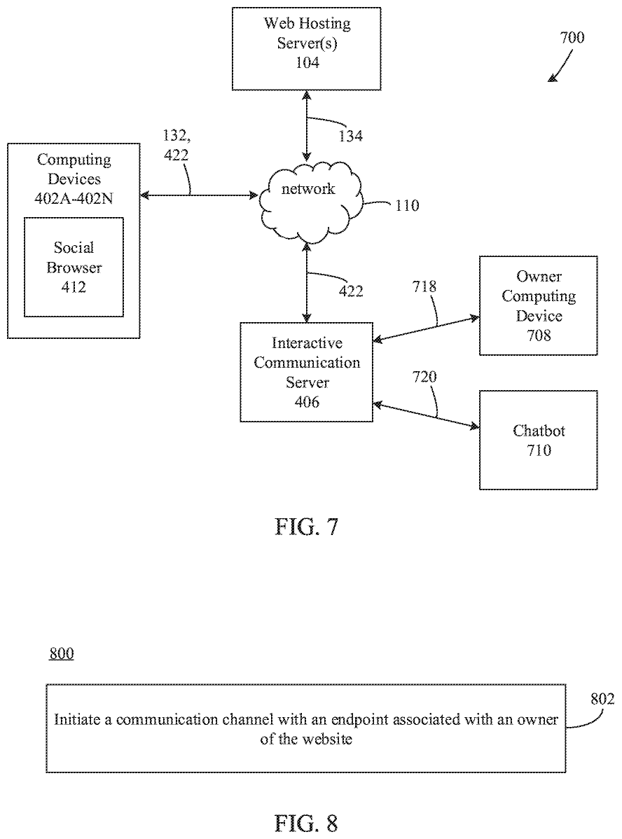

Accordingly, in example embodiments, users of computing devices 402A-402N may interact with an endpoint associated with a website owner. For instance, FIG. 8 shows a flowchart 800 of a method for establishing a communication channel with an endpoint associated with an owner of a website, according to an example embodiment. In an example, the method of flowchart 800 may be implemented by system 700, as shown in FIG. 7. Other structural and operational implementations will be apparent to persons skilled in the relevant art(s) based on the following discussion regarding flowchart 800.

Flowchart 800 begins with step 802. In step 802, a communication channel is initiated with an endpoint associated with an owner of a website. For instance, with respect to FIGS. 4 and 7, interactive communication controller 408 may initiate 718 a two-way communication channel with owner computing device 708 and/or initiate 720 a two-way communication channel with chatbot 710 via network 110 and interactive communication server 406. In example embodiments, when a user of social browser 412 visits a website, social browser 412 may enable the user to interact with an interface element to initiate a communication channel with an endpoint associated with the website's owner, such as a customer service representative. In this manner, a website visitor may communicate with a company representative associated with the website to answer a question related to a product offering, discuss product features, prices, etc.

Display interface 418 of one of computing devices 402A-402N from which the message originated ay be configured to display the interactive two-way communication channel with the endpoint associated with the website owner as a separate chat window. For instance, while messages sent and received as described above with respect to FIG. 4 may be displayed publicly, e.g., to all website visitors accessing the same website, communications with an endpoint associated with a website owner may remain private such that non-participating website visitors cannot see such messages. In other implementations, however, non-participating website visitors may also be able to see such communications involving other visitors and an endpoint associated with an owner of the website.

In some examples, interactive communication server 406 may transmit or forward a message received from one of computing devices 402A-402N to owner computing device 708, which may comprise a desktop computer, tablet, smartphone, etc. In some implementations, the message may be transmitted through a customer relationship management (CRM) system to owner computing device 708. In some other examples, the message may be transmitted via one or more cellular communications to a mobile phone in a short message service (SMS) format. In yet other examples, the message may be transmitted via an email message or any other electronic communication (e.g., communication services including but not limited to Skype™, GoToMeeting™, etc.). In such examples, a user of owner computing device 708 that receives the message may respond to the message transmitted by one of computing devices 402A-402N via the same communication manner that the message was received (e.g., via a CRM system, SMS message, email, etc.), causing the response to be communicated back to the appropriate computing device 402A-402N via interactive communication server 406 and network 110. In this way, an owner of a website need not develop separate software and/or communication interfaces in order to interact with customers, and instead may be enabled to utilize functionality implemented within social browser 412 and interactive communication server 406.

In some examples, interactive communication server 406 and/or owner computing device 708 may comprise a log or history of interactions with users of computing devices 402A-402N. For instance, the log or history may be stored in a database or other data structure on or accessible by interactive communication server 406 and/or computing device 708. In some examples, the log or history may be stored in a CRM system associated with the owner of the website.

Although it is illustrated in FIG. 7 that an endpoint associated with an owner of a website may comprise owner computing device 708, example embodiments may also include instances where the endpoint associated with the website owner comprises one of computing devices 402A-402N. For instance, a representative may login to an appropriate interface (e.g., social browser 412, or another application or service accessible on the computing device) to receive and/or transmit messages as a representative associated with the owner of the website. In some example embodiments, social browser 412 and/or interactive communication server 406 may determine, based on user authentication information, that the user is an endpoint associated with the owner of the website and present a different interface to the user via display interface 418. For example, display interface 418 may enable the representative to view and/or respond to one or more messages from a plurality of visitors associated with the website identifier. Display interface 418 may be configured to present messages in various ways, including by arranging messages in tabs, grouped into folders, grouped by time, geography, product categorizations, website identifiers, etc. In some instances, display interface 418 may provide the representative with one or more interactive interface elements to respond to one or more messages, close messages, save messages, forward or escalate messages to other representatives, etc. via social browser 412.

In some example embodiments, social browser 412 may determine that a user of one of computing devices 402A-402N is an endpoint associated with an owner of the website based on a key stored on a website root directory. In implementations, the key may indicate an identity of one or more users that are endpoints associated with an owner of the website. For instance, when the user navigates social browser 412 to the website for which the user is designated as an endpoint, the computing device may access and/or download the key. In some instances, the key may comprise a public key, hash, or a signed file specific to the domain in which the key is located. Social browser 412 may authenticate the user as an endpoint by comparing a separate key, has, or other information such as login credentials on the endpoint's computing device with the key accessible on the domain. Based on such a comparison, social browser 412 may authenticate a user of one of computing devices 402A-402N as an endpoint associated with the owner, thereby enabling display interface 418 to present one or more owner-related interface elements described herein.

Owner computing device 708 may comprise a plurality of endpoints (e.g., computing devices) in some implementations, such as a team of representatives associated with the owner of the website. In some implementations, an owner (including but not limited to an administrator, manager, team leader, etc.) of a website may interact with interactive communication server 406 via a web browser, such as social browser 412, to configure one or more endpoints associated with the owner. For instance, the owner of the website may login to an account associated with the website identifier to identify owner computing device 708 (or a plurality of such computing devices) to receive and/or transmit messages generated by users of computing device 402A-402N. In some example embodiments, the owner may identify an entire team or group associated with the website, or individually identify particular endpoints to receive and/or transmit such messages. In yet other implementations, the owner may configure one or more communication channels for which messages may be transmitted and/or received, such as via email, SMS messages, a CRM system, and/or any other communication channel. The owner may further be enabled to configure one or more permission level associated with each endpoint, such as the ability for the particular endpoint to add other endpoints, receive messages, respond to messages, etc. In yet another implementation, the owner of a website may identify chatbot 710 for which interactions should be transmitted for automated responses on behalf of the website owner.

In some implementations, the endpoint associated with the owner of the website may be configured to receive information corresponding to the identity of the accessed website. For example, message transmitter 410 of one of computing devices 402A-402N (e.g., a visitor to a company's website seeking additional product-related information) may transmit information corresponding to the website currently accessed in social browser 412 on the website visitor's computing device. In one example, the information corresponding to the website currently being accessed may include an associated website identifier. In another example, the information may include a screenshot or other information identifying a particular item, section, or listing the website visitor is currently viewing in social browser 412. In this manner, the endpoint associated with the owner of the website may receive information corresponding to the content the visitor is currently viewing, thus enabling a representative to provide more accurate and relevant information in response to a website visitor's inquiry.

### III. Example Computer System Implementation

One or more of the components of computing device 102, web hosting server(s) 104, feedback repository server 106, repository 108, computing devices 402A-402N, web interactive communication server 406, owner computing device 708, chatbot 710, and one or more steps of flowcharts 200, 300, 500, 600, and 800 may be implemented in hardware, or hardware combined with software and/or firmware. For example, one or more of the components of computing device 102, web hosting server(s) 104, feedback repository server 106, repository 108, computing devices 402A-402N, web interactive communication server 406, owner computing device 708, chatbot 710, and one or more steps of flowcharts 200, 300, 500, 600, and 800 may be implemented as computer program code/instructions configured to be executed in one or more processors and stored in a computer readable storage medium.

In another implementation, one or more of the components of computing device 102, web hosting server(s) 104, feedback repository server 106, repository 108, computing devices 402A-402N, web interactive communication server 406, owner computing device 708, chatbot 710, and one or more steps of flowcharts 200, 300, 500, 600, and 800 may also be implemented in hardware that operates software as a service (SaaS) or platform as a service (PaaS). Alternatively, one or more of the components of computing device 102, web hosting server(s) 104, feedback repository server 106, repository 108, computing devices 402A-402N, web interactive communication server 406, owner computing device 708, chatbot 710, and one or more steps of flowcharts 200, 300, 500, 600, and 800 may be implemented as hardware logic/electrical circuitry.

For instance, in an implementation, one or more of the components of computing device 102, web hosting server(s) 104, feedback repository server 106, repository 108, computing devices 402A-402N, web interactive communication server 406, owner computing device 708, chatbot 710, and one or more steps of flowcharts 200, 300, 500, 600, and 800 may be implemented together in a system on a chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

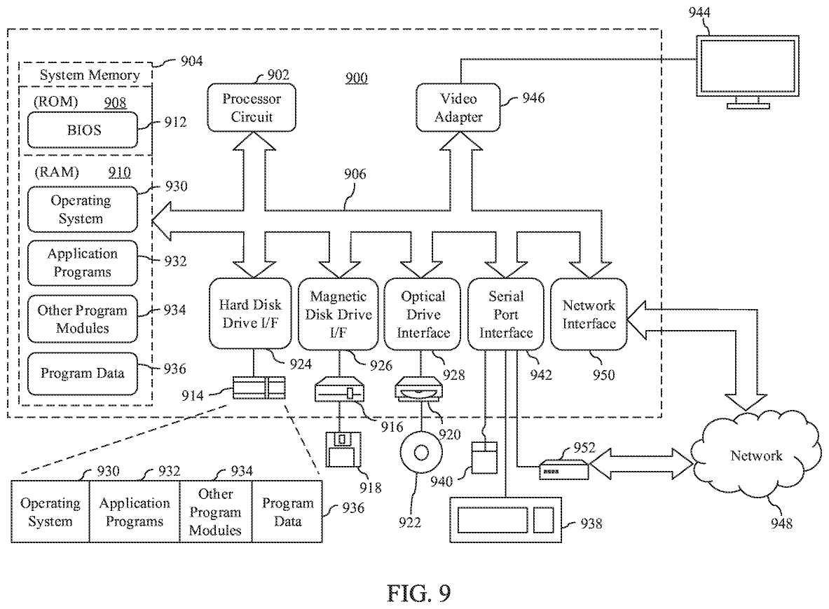

FIG. 9 depicts an implementation of a computing device 900 in which example embodiments may be implemented. For example, computing device 102, web hosting server(s) 104, feedback repository server 106, repository 108, computing devices 402A-402N, web interactive communication server 406, owner computing device 708, and chatbot 710 may each be implemented in one or more computing devices similar to computing device 900 in stationary or mobile computer implementations, including one or more features of computing device 900 and/or alternative features. The description of computing device 900 provided herein is provided for purposes of illustration, and is not intended to be limiting. Example embodiments may be implemented in further types of computer systems, as would be known to persons skilled in the relevant art(s).

As shown in FIG. 9, computing device 900 includes one or more processors, referred to as processor circuit 902, a system memory 904, and a bus 906 that couple various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random-access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing one or more of the components of computing device 102, web hosting server(s) 104, feedback repository server 106, repository 108, computing devices 402A-402N, web interactive communication server 406, owner computing device 708, chatbot 710, one or more steps of flowcharts 200, 300, 500, 600, and 800 and/or further implementations described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, stylus, pen, pointing device, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Implementations are also directed to such communication media that are separate and non-overlapping with implementations directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of example embodiments discussed herein. Accordingly, such computer programs represent controllers of the computing device 900.

Implementations are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A system for establishing a communication channel in a web browser is described herein. The system includes: a processor circuit; and a memory that stores program code configured to be executed by the processor circuit, the program code comprising: a web browser comprising: a website content interface for providing a request to access a website hosted by a website hosting server; a user interactive control configured to initiate a two-way communication channel with a communication server, the two-way communication channel comprising: a message transmitter for transmitting one or more user-generated messages to the communication server, the one or more user-generated messages including a website identifier corresponding to the website; and a message receiver for receiving one or more messages from the communication server corresponding to the website identifier; and a display interface configured to display website content received from the website hosting server, the one more transmitted user-generated messages, and the one or more received messages.

In one implementation of the foregoing system, the web browser comprises an authentication interface configured to authenticate a user of the web browser prior to initiating the two-way communication channel.

In another implementation of the foregoing system, the two-way communication channel is initiated with at least one other user accessing the website.

In another implementation of the foregoing system, the two-way communication channel is initiated with an endpoint associated with an owner of the website.

In another implementation of the foregoing system, the endpoint comprises a chatbot.

In another implementation of the foregoing system, the message transmitter is configured to transmit information corresponding to the identity of the accessed website to the endpoint.

In another implementation of the foregoing system, the web browser further comprises: an online indicator configured to: transmit an online notification to the communication server in response to receiving the request to access the website; and receive from the communication server an indication of a number of online users corresponding to the website identifier.

A method of establishing a communication channel in a web browser is described herein. The method includes: providing a request to access a website hosted by a website hosting server; initiating a two-way communication channel with a communication server, the initiating the two-way communication channel comprising: transmitting one or more user-generated messages to the communication server, the one or more user-generated messages including a website identifier corresponding to the website; and receiving one or more messages from the communication server corresponding to the website identifier; and displaying website content received from the website hosting server, the one more transmitted user-generated messages, and the one or more received messages.

In one implementation of the foregoing method, the method further comprises authenticating a user of the web browser prior to initiating the two-way communication channel.

In another implementation of the foregoing method, the initiating the two-way communication channel comprises initiating a communication channel with at least one other user accessing the website.

In another implementation of the foregoing method, the initiating the two-way communication channel comprises initiating a communication channel with an endpoint associated with an owner of the website.

In another implementation of the foregoing method, the endpoint comprises a chatbot.

In another implementation of the foregoing method, the transmitting the one or more user-generated messages comprises transmitting information corresponding to the identity of the accessed website to the endpoint.

In another implementation of the foregoing method, the method further comprises: transmitting an online notification to the communication server in response to receiving the request to access the website; and receiving from the communication server an indication of a number of online users corresponding to the website identifier.

A method performed by a web browser for obtaining and displaying information corresponding to a website is described herein. The method includes: providing, by the web browser, an access request to access the website to a server hosting the website; providing, by the web browser, a feedback request for information associated with the website to a feedback repository server, the feedback request including a website identifier; receiving, from the server hosting the website, web page content corresponding to website; receiving, from the feedback repository server, one or more items of feedback associated with the website; and displaying, in the web browser, the web page content and the one or more items of feedback.

In one implementation of the foregoing method, the one or more items of feedback comprise one or more items of user-generated ratings associated with the website.

In another implementation of the foregoing method, the one or more items of feedback comprise one or more items of user-generated messages associated with the website.

In another implementation of the foregoing method, the method further comprises: authenticating a user of the web browser; receiving feedback associated with the website generated by the user; and transmitting the feedback to the feedback repository server.

In another implementation of the foregoing method, the server hosting the website is not affiliated with the feedback repository server.

In another implementation of the foregoing method, the method further comprises: providing a user interactive control configured to disable displaying the one or more items of feedback in the web browser.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the present invention should not be limited by any of the above-described example embodiments, but should be defined only in accordance with the following claims and their equivalents.

What is claimed is:

1. A system for establishing a communication channel in a web browser, comprising:
a processor circuit; and
a memory that stores program code configured to be executed by the processor circuit, the program code comprising:
a web browser comprising:
a website content interface for providing a request to access a website hosted by a website hosting server;
a user interactive control configured to initiate a two-way communication channel with a communication server, the two-way communication channel comprising:
a message transmitter for transmitting one or more user-generated messages to the communication server, the one or more user-generated messages including a website identifier corresponding to the website; and
a message receiver for receiving one or more messages from the communication server corresponding to the website identifier; and
a display interface configured to display website content received from the website hosting server, the one more transmitted user-generated messages, and the one or more received messages.

2. The system of claim 1, wherein the web browser comprises an authentication interface configured to authenticate a user of the web browser prior to initiating the two-way communication channel.

3. The system of claim 1, wherein the two-way communication channel is initiated with at least one other user accessing the website.

4. The system of claim 1, wherein the two-way communication channel is initiated with an endpoint associated with an owner of the website.

5. The system of claim 4, wherein the endpoint comprises a chatbot.

6. The system of claim 4, wherein the message transmitter is configured to transmit information corresponding to the identity of the accessed website to the endpoint.

7. The system of claim 1, wherein the web browser further comprises:
an online indicator configured to:
transmit an online notification to the communication server in response to receiving the request to access the website; and
receive from the communication server an indication of a number of online users corresponding to the website identifier.

8. A method of establishing a communication channel in a web browser, comprising:
providing a request to access a website hosted by a website hosting server;
initiating a two-way communication channel with a communication server, the initiating the two-way communication channel comprising:
transmitting one or more user-generated messages to the communication server, the one or more user-generated messages including a website identifier corresponding to the website; and
receiving one or more messages from the communication server corresponding to the website identifier; and
displaying website content received from the website hosting server, the one more transmitted user-generated messages, and the one or more received messages.

9. The method of claim 8, further comprising authenticating a user of the web browser prior to initiating the two-way communication channel.

10. The method of claim 8, wherein the initiating the two-way communication channel comprises initiating a communication channel with at least one other user accessing the website.

11. The method of claim 8, wherein the initiating the two-way communication channel comprises initiating a communication channel with an endpoint associated with an owner of the website.

12. The method of claim 11, wherein the endpoint comprises a chatbot.

13. The method of claim 11, wherein the transmitting the one or more user-generated messages comprises transmitting information corresponding to the identity of the accessed website to the endpoint.

14. The method of claim 8, further comprising:
transmitting an online notification to the communication server in response to receiving the request to access the website; and
receiving from the communication server an indication of a number of online users corresponding to the website identifier.

15. A method performed by a web browser for obtaining and displaying information corresponding to a website, the method comprising:
providing, by the web browser, an access request to access the website to a server hosting the website;
providing, by the web browser, a feedback request for information associated with the website to a feedback repository server, the feedback request including a website identifier;
receiving, from the server hosting the website, web page content corresponding to website;
receiving, from the feedback repository server, one or more items of feedback associated with the website; and
displaying, in the web browser, the web page content and the one or more items of feedback.

16. The method of claim 15, wherein the one or more items of feedback comprise one or more items of user-generated ratings associated with the website.

17. The method of claim 15, wherein the one or more items of feedback comprise one or more items of user-generated messages associated with the website.

18. The method of claim 15, further comprising:
authenticating a user of the web browser; and
receiving an item of feedback associated with the website generated by the user;
transmitting the item of feedback to the feedback repository server.

19. The method of claim 15, wherein the server hosting the website is not affiliated with the feedback repository server.

20. The method of claim 15, further comprising:
providing a user interactive control configured to disable displaying the one or more items of feedback in the web browser.
